(19) United States
(12) Patent Application Publication
(10) Pub. No.: US 2022/0329119 A1
(43) Pub. Date: Oct. 13, 2022

(54) Rotor Device and Stator Device for a Flat Brushless Electric Motor and Flat, Brushless Electric Motor for Roof System of an Automobile

(71) Applicant: Webasto SE, Stockdorf (DE)

(72) Inventors: Ramalingesh SUNILKUMAR, Stockdorf (DE); Rajesh Gurupatham JAYARAJ, Stockdorf (DE); Levente GYERKO, Stockdorf (DE)

(21) Appl. No.: 17/635,963

(22) PCT Filed: Aug. 5, 2020
(86) PCT No.: PCT/EP2020/071990

§ 371 Date: Feb. 16, 2022

(30) Foreign Application Priority Data
Aug. 22, 2019 (DE) 10 2019 122 603.1

(51) Int. Cl. H02K 1/2791; H02K 1/02; H02K 1/14; H02K 5/173; H02K 15/095; H02K 15/03

(52) U.S. Cl. CPC H02K 1/2791; H02K 1/02; H02K 1/14; H02K 5/1737; H02K 15/095; H02K 15/03

(57) ABSTRACT

A rotor device for a flat brushless electric motor for an automobile roof system has a rotor housing having a first cylinder and a second cylinder. The cylinder elements are configured to be hollow-cylindrical, have different internal and external diameters such that a stator device is disposable between the cylinder elements, and are concentrically aligned with one another. At least one magnetic module is disposed on each cylinder element. A stator device for a stator housing element has a base and a wall element mutually disposed so that the stator housing element is configured in the manner of a pot; and an axle element for externally disposing a rolling bearing for a rotor device. The axle element is disposed in the center of the stator housing element such that the axle element and the wall element, viewed in cross section, extend away from the base element in the same direction.

The invention relates to a rotor device as well as to a stator device for a flat brushless electric motor, in particular for a roof system of an automobile, and to a flat brushless electric motor for a roof system of an automobile.

A flat brushless electric motor is usually configured as a so-called external rotor or as a so-called internal rotor.

This means that a rotor device, in the case of an external rotor, has magnets of dissimilar polarization that rotate externally about a stator device when the stator device is supplied with electric power.

In contrast, the magnets of the rotor device in the case of an internal rotor are surrounded by the stator device.

In summary, and in other words, the rotor device in an external rotor rotates externally about the stator device, whereas the rotor device in an internal rotor is surrounded by the stator device and rotates in the interior of the latter.

These conventional brushless electric motors have to be produced with high precision, the mass production being cost-intensive as a result thereof.

Also, motors of this type can produce only a minor torque which however is insufficient in order to meet the increasing safety requirement pertaining to, for example, a folding or a sliding roof system of an automobile. This is because the mass of the roof elements of a roof system of this type that have to be moved also increases along with the increasing safety requirement.

It is, therefore, an object of the present invention to specify a rotor device as well as preferably a stator device for a flat brushless electric motor, in particular for a roof system of an automobile, or else a flat brushless electric motor which can be produced in a cost-effective and material-saving manner and preferably makes available an increased torque and in terms of the dimensions thereof in this case favourably competes with known devices and motors.

These objects are achieved according to the invention by the features of the independent patent claims. Further advantageous refinements are the subject matter of the dependent claims.

In a first aspect of the present invention, a rotor device for a flat brushless electric motor, in particular for a roof system of an automobile, comprises according to the invention:
a rotor housing element having a first cylinder element and a second cylinder element;
wherein a rolling bearing is able to be disposed preferably on the first cylinder element on the internal site, on the inner shell face of the latter;
wherein the cylinder elements are configured so as to be hollow-cylindrical, have different internal and external diameters such that a stator device is able to be disposed between the cylinder elements, and are concentrically aligned with one another;
wherein the internal diameter of the second cylinder element is configured so as to be larger than the external diameter of the first cylinder element.

At least one magnetic module is preferably disposed on each cylinder element. In comparison to solutions from the prior art, in this way there are thus preferably available at least two magnetic modules by way of which it is possible to generate a torque which also meets the increasing safety requirements pertaining to a folding or a sliding roof system and the greater mass associated therewith. This is because it is possible to safely move also comparatively heavy roof elements of a folding or sliding roof system at an adequate speed by way of a sufficiently high torque.

It is furthermore preferable that the first cylinder element has a first magnetic module, wherein the first magnetic module is preferably configured so as to be hollow-cylindrical.

It is furthermore possible that the first cylinder element has an inner shell face and an outer shell face, wherein the first magnetic module is preferably disposed on the outer shell face of the first cylinder element.

It can also be provided that the first magnetic module comprises a magnetizable material so as to preferably configure dissimilar magnetic poles. A material of this type permits the configuration of magnetic poles after the magnetic module has been assembled on the cylinder element, for example.

The second cylinder element advantageously has a second magnetic module, wherein the second magnetic module is preferably configured so as to be hollow-cylindrical.

It is furthermore advantageous for the second cylinder element to have an inner shell face and an outer shell face, wherein the second magnetic module is preferably disposed on the inner shell face of the second cylinder element.

It is furthermore advantageous for the second magnetic module to comprise a magnetizable material so as to configure dissimilar magnetic poles. For example, the afore-mentioned magnetizable material thus permits magnetic poles to be able to be configured after the magnetic module has been assembled on the cylinder element.

It is particularly favourable for the first and the second magnetic module of the corresponding cylinder elements in the radial direction to be identical in terms of pole pairs and the number of pole pairs. An efficient electric motor can be implemented in this way.

The rotor housing element favourably has an annular disc element, in particular as the base of the rotor housing element, said annular disc element in the radial direction having an internal side and an external side.

It is also favourable for the first cylinder element to be disposed on the internal side, in particular on the inner, circular clearance of the disc element, or on the periphery of the latter, respectively.

The second cylinder element is preferably disposed on the external side, in particular on the outer periphery of the disc element.

It can furthermore be provided that the internal side of the disc element and the inner shell face of the first cylinder element transition into one another in a planar manner.

The external side of the disc element and the outer shell face of the second cylinder element preferably transition into one another in a planar manner.

In other words, it is advantageous for the rotor housing element to be configured so as to be unitary with the cylinder elements and the disc element.

It is possible here that the rotor housing element will be, or is, respectively, produced by a deep-drawing method or by a pressing method.

A second aspect of the present invention comprises a method for magnetizing a rotor device, or for configuring magnetic poles in a rotor device, respectively.

It is explicitly pointed out that the features of the rotor device as mentioned in the context of the first aspect, individually or combined with one another, may be used in the method for magnetizing a rotor device.

In other words, the features relating to the rotor device and mentioned above in the context of the first aspect of the invention can be combined with further features also in the context of the second aspect of the invention here.

The method advantageously utilizes a rotor device according to the first aspect.

It is furthermore advantageous for the method to utilize a magnetizing installation for magnetizing magnetizable material, said magnetizing installation being able to be disposed in the intermediate space between the cylinder elements of the rotor housing element of the rotor device.

The magnetizing installation advantageously has at least one coil element for generating a magnetic field, and preferably at least one core element, in particular an iron core, for amplifying the magnetic field that is able to be generated by at least one coil element.

The method according to the invention preferably comprises the following steps.

One step of the method advantageously comprises positioning the rotor device and the magnetizing installation. In other words, in a first step the rotor device and the magnetizing installation have to be mutually positioned.

One step of the method preferably comprises inserting the magnetizing installation in the intermediate space between the cylinder elements of the rotor housing element of the rotor device. The magnetizing installation is thus ready for magnetizing the rotor device.

It is furthermore favourable for one step of the method to comprise collectively magnetizing the first and the second magnetic module such that the cylinder elements are identical in terms of pole pairs and the number of pole pairs. It is thus achieved in this step that, apart from the exact number of the pole pairs and the magnetic alignment (north pole, south pole) associated therewith, also the position of the generated poles in the cylinder elements is able to be exactly predetermined.

It is also advantageous for one step of the method to comprise extracting the magnetizing installation from the intermediate space. The magnetizing device can thus be positioned in relation to a further rotor device, and the method can be repeated.

A third aspect of the present invention relates to a stator device for a flat brushless electric motor, in particular for a roof system of an automobile.

It is explicitly pointed out that the features of the rotor device as mentioned in the context of the first aspect, individually or combined with one another, may be used in the stator device.

In other words, the features relating to the rotor device and mentioned above in the context of the first aspect of the invention can be combined with further features also in the context of the third aspect of the invention here.

Of course, it is also possible to combine the features of the second aspect of the invention with features of the first and the third aspect.

A stator device for a flat brushless electric motor, in particular for a roof system of an automobile, preferably has:
a stator housing element having a base element and a wall element which are mutually disposed in such a manner that the stator housing element is configured so as to be pot-shaped; and
an axle element for externally disposing a rolling bearing for a rotor device.

The axle element is preferably configured as a projecting pin or the like, in particular from a solid material.

It is furthermore preferable for the axle element to be disposed in the centre of the stator housing element and such that the axle element and the wall element, when viewed in the cross section, extend away from the base element in the same direction.

The stator housing element and the axle element are favourably configured in one part, or so as to be mutually integral, respectively.

It is also favourable for the axle element to comprise a securing installation for securing a rolling bearing, in particular a circlip having a corresponding clearance on the axle element.

The stator device advantageously comprises a housing part for attaching a multiplicity of tooth elements.

It is furthermore advantageous for the housing part to be configured as a disc-shaped plate.

It is furthermore advantageous for a multiplicity of tooth elements to be fixedly connected to the housing part, in particular integrally cast with the latter, preferably cast by means of a plastics material.

The stator device preferably has at least one tooth element for winding a coil assembly thereon, wherein the at least one tooth element preferably has an inner end and an outer end and disposed therebetween a receptacle for a wound coil assembly.

It is also preferable for the stator device to comprise a coil assembly having a wire element which is wound about the receptacle of the tooth element.

The coil assembly is preferably integrally cast with the tooth element, in particular with the aid of a plastics material.

It is furthermore possible that the at least one tooth element on the inner end and on the outer end has a sub-face of an internal circumferential face and a sub-face of an external circumferential face so as to form an internal circumferential face and an external circumferential face.

The internal circumferential face is preferably adapted to an outer shell face of a first cylinder element, in particular to an outer shell face of a first magnetic module of a first cylinder element, of a rotor device, such that the internal circumferential face and the outer shell face are able to be mutually separated by way of an air gap.

It is furthermore preferable that the external circumferential face is adapted to an inner shell face of a second cylinder element, in particular to an inner shell face of a second magnetic module of a second cylinder element, of a rotor device, such that the external circumferential face and the inner shell face are able to be mutually separated by way of an air gap.

A fourth aspect of the present invention comprises a flat brushless electric motor for a roof system of an automobile.

It is explicitly pointed out that the features of the rotor device as mentioned in the context of the first aspect, individually or combined with one another, may be used in the motor.

It is also pointed out that the features of the stator device as mentioned in the context of the third aspect, individually or combined with one another, may be used in the motor.

In other words, the features relating to the rotor device and mentioned above in the context of the first aspect of the invention, and the features relating to the stator device and mentioned above in the context of the third aspect of the invention, can be combined with further features also in the context of the fourth aspect of the invention here.

Of course, it is also possible to combine features of the third aspect with the features of the first, the second and the fourth aspect of the present invention.

A flat brushless electric motor for a roof system of an automobile preferably comprises:
a rotor device according to the first aspect; and
a stator device according to the third aspect.

It is also preferable that the rotor device is connected to the axle element of the stator device by way of a rolling bearing such that the rotor device and the stator device are rotatable relative to one another.

The rolling bearing is preferably disposed externally on the axle element of the stator device and internally in the first cylinder element of the rotor device.

In this context, it is advantageous for the rolling bearing to be preassembled either on the rotor device or on the stator device.

It is furthermore favourable for the motor to have a motor housing element for closing the motor and for fastening to the stator housing element.

With the aid of the rotor device and the stator device it is possible to construct a motor of which the effective overall torque is improved in comparison to solutions from the prior art of identical size.

With the aid of the motor according to the invention, and also with the aid of the method according to the invention (cf. the second aspect of the present invention) the production and assembly process can also be simplified. Overall, an improvement of the entire (manufacturing) cycle time can even be achieved.

A surprisingly effect that has furthermore been observed is that the described construction of the motor according to the invention causes a significant reduction in the noise generated, specifically as a result of the configuration of the axle element on the stator housing element, or on the stator device, respectively, and of the positioning of the rolling bearing.

The invention will be explained in more detail hereunder by means of exemplary embodiments in conjunction with associated drawings in which, in a schematic manner:

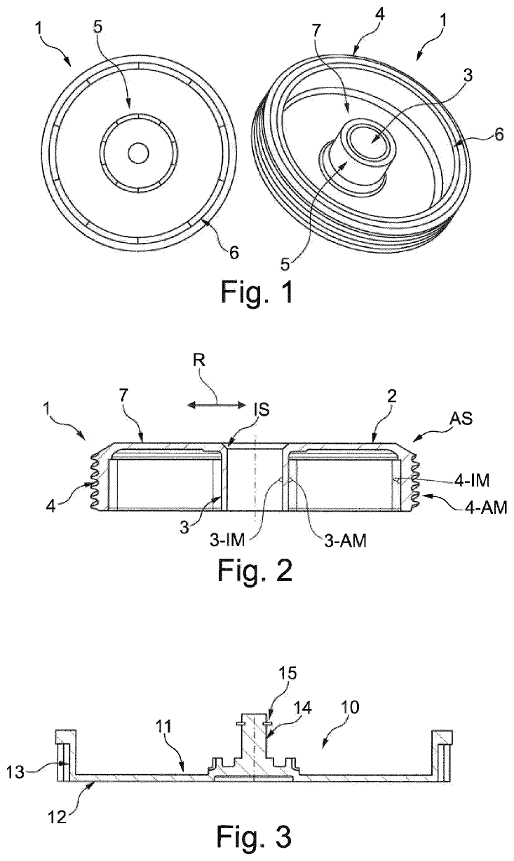

FIG. 1 shows a schematic plan view of a rotor device according to the invention as well as an isometric view of the rotor device according to the invention;

FIG. 2 shows a sectional view of the rotor device according to the invention from FIG. 1;

FIG. 3 shows a sectional view of a stator device according to the invention;

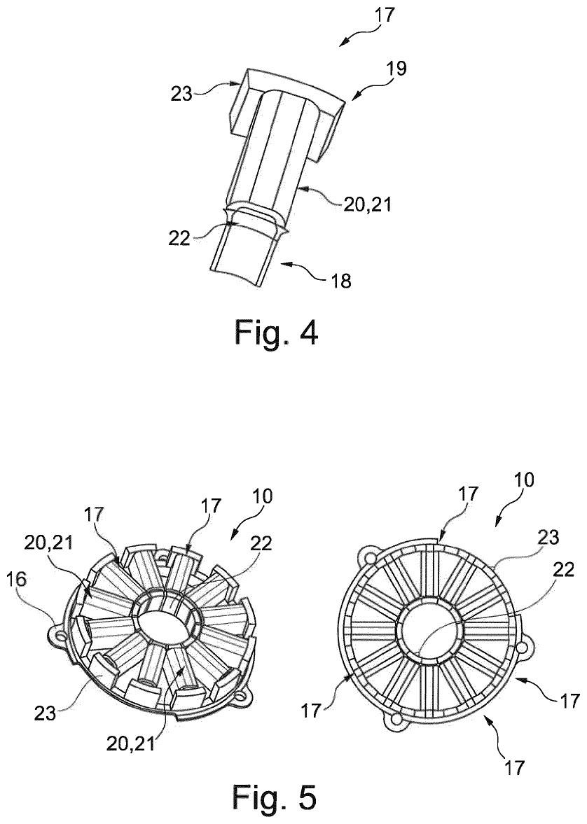

FIG. 4 shows an isometric view of a tooth element of the stator device according to the invention;

FIG. 5 shows an isometric view and a plan view of a housing part of the stator device according to the invention, having a multiplicity of tooth elements;

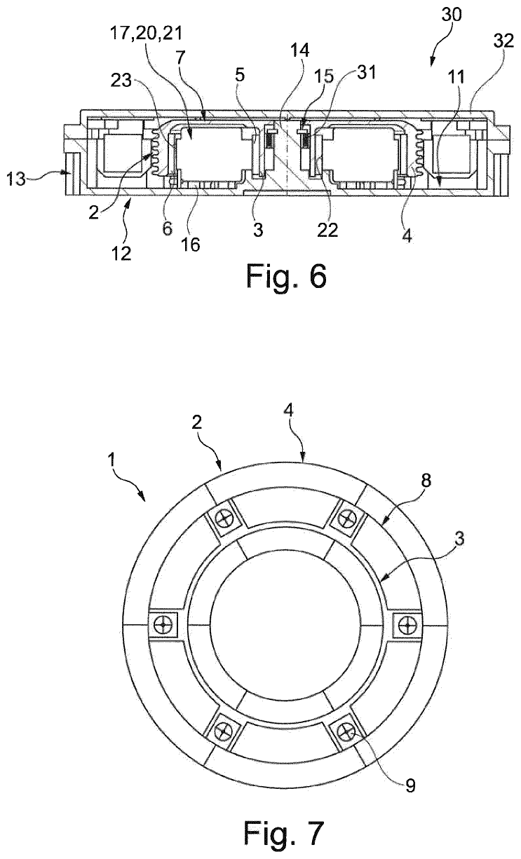

FIG. 6 shows a sectional view of a flat brushless electric motor according to the invention; and

FIG. 7 shows a plan view of the rotor device from FIG. 1, having a magnetizing installation.

The same reference signs are used for the identical subject matter in the description hereunder.

FIG. 1 shows a schematic plan view of a rotor device 1 according to the invention as well as an isometric view of the rotor device 1 according to the invention, wherein FIG. 2 represents a sectional view of the rotor device according to the invention from FIG. 1.

For the sake of simplicity and briefness, FIGS. 1 and 2 will be collectively described hereunder.

FIGS. 1 and 2 more specifically illustrate a rotor device 1 for a flat brushless electric motor 30, in particular for a roof system of an automobile.

The rotor device 1 here has a rotor housing element 2 having a first cylinder element 3 and a second cylinder element 4, wherein a rolling bearing 31 is able to be disposed on the internal side on the first cylinder element 3 on the inner shell face 3-IM of the latter.

The cylinder elements 3, 4 are configured so as to be hollow-cylindrical, have different internal and external diameters such that a stator device 10 is able to be disposed between the cylinder elements 3, 4, and are concentrically aligned with one another.

The internal diameter of the second cylinder element 4 here is configured so as to be larger than the external diameter of the first cylinder element 3.

FIGS. 1 and 2 furthermore show that one magnetic module 5, 6 is disposed on each cylinder element 3, 4.

The first cylinder element 3 thus has a first magnetic module 5 which is configured so as to be hollow-cylindrical.

The first cylinder element 3 has an inner shell face 3-IM and an outer shell face 3-AM, wherein the first magnetic module 5 is disposed on the outer shell face 3-AM of the first cylinder element 3.

Furthermore, the second cylinder element 4 has a second magnetic module 6 which is configured so as to be hollow-cylindrical, wherein the second cylinder element 4 has an inner shell face 4-IM and an outer shell face 4-AM.

The second magnetic module 6 is disposed on the inner shell face 4-IM of the second cylinder element 4.

The second magnetic module 6 as well as the first magnetic module 5 comprise a magnetizable material so as to configure dissimilar magnetic poles.

As FIG. 1 shows in the schematic illustration thereof, the first and the second magnetic module 5, 6 of the corresponding cylinder elements 3, 4, in the radial direction are identical in terms of pole pairs and the number of pole pairs.

FIG. 2 shows in particular that the rotor housing element 2 comprises an annular disc element 7, in particular as the base of the rotor housing element 2, which in the radial direction R has an internal side IS and an external side AS.

Here, the first cylinder element 3 is disposed internally, in particular on the inner, circular clearance of the disc element or on the periphery of the latter, respectively, and the second cylinder element 4 is disposed externally, in particular on the outer periphery of the disc element 7.

More specifically illustrated, the internal side IS of the disc element 7 and the inner shell face 3-IM of the first cylinder element 3 transition into one another in a planar manner, wherein the external side AS of the disc element 7 and the external shell face 4-AM of the second cylinder element 4 also transition into one another in a planar manner.

The rotor housing element 2 here is configured in a unitary manner with the cylinder elements 3, 4 and the disc element 7, and is produced by a deep-drawing method or by a pressing method.

FIG. 3 shows a sectional view of a stator device 10 according to the invention for a flat brushless electric motor 30, in particular for a roof system of an automobile.

The stator device 10 here has a stator housing element 11 having a base element 12 and a wall element 13 which are mutually disposed in such a manner that the stator housing element 11 is configured so as to be pot-shaped.

Furthermore, the stator device 10 has an axle element 14 for externally disposing a rolling bearing 31 for a rotor device 1, wherein the axle element 14 is disposed in the centre of the stator housing element 11 and such that the axle element 14 and the wall element 13, when viewed in the cross section, extend away from the base element 12 in the same direction.

FIG. 3 also shows that the stator housing element 11 and the axle element 14 are configured so as to be unitary, or mutually integral, respectively, wherein the axle element 14 has a securing installation 15 for securing a rolling bearing, in particular a circlip having a corresponding clearance on the axle element 14.

FIG. 4 shows an isometric view of a tooth element 17 of the stator device 10 according to the invention, wherein FIG. 5 shows an isometric view and a plan view of a housing part 16 of the stator device 10 according to the invention, having a multiplicity of tooth elements 17.

As has already been mentioned, the stator device 10 has a housing part 16 for attaching a multiplicity of tooth elements 17, wherein the housing part 16 is configured as a disc-shaped plate.

The multiplicity of tooth elements 17 here are fixedly connected to the housing part 16, in particular integrally cast with the latter (cf. in particular FIG. 5).

It is shown in FIGS. 4 and 5 that the stator device 10 has various tooth elements 17 for winding a coil assembly 21 thereon.

Each tooth element 17 has an inner end 18 and an outer end 19 and, disposed therebetween, a receptacle 20 for a wound coil assembly 21 which comprises a wire element which is wound about the receptacle 20 of the tooth element 17.

The coil assembly is integrally cast with the tooth element 17.

As is shown in FIG. 4, a tooth element 17 on the inner end 18 and on the outer end 19 has a sub-face 22 of an internal circumferential face and a sub-face 23 of an external circumferential face so as to form an internal circumferential face and an external circumferential face.

The internal circumferential face here is adapted to an outer shell face 3-AM of the first cylinder element 3, in particular to an outer shell face of the first magnetic module 5 of the first cylinder element 3, of the rotor device 1, such that the internal circumferential face and the outer shell face are able to be mutually separated by way of an air gap.

The external circumferential face is adapted to an inner shell face 4-IM of the second cylinder element 4, in particular to an inner shell face of the second magnetic module 6 of the second cylinder element 4, of the rotor device 1, such that the external circumferential face and the inner shell face are able to be mutually separated by way of an air gap.

The afore-mentioned situations will be highlighted with reference to FIG. 6.

FIG. 6 thus shows a sectional view of a flat brushless electric motor 30 according to the invention for a roof system of an automobile.

The motor 30 according to FIG. 6 has a rotor device 1 as is illustrated in FIGS. 1 to 3, and a stator device 10 as shown in FIGS. 4 and 5.

The rotor device 1 by way of a rolling bearing 31 is connected to the axle element 14 of the stator device 10 such that the rotor device 1 and the stator device 10 are rotatable relative to one another.

The motor furthermore has a motor housing element 32 for closing the motor 30 and for fastening to the stator housing element 11.

Of course, the motor 30 also has connectors for supplying electric power, such that the rotor device can generate a torque relative to the stator device.

It is specifically the dual configuration of a magnetic module 5, 6 on the rotor device 1 that achieves a motor which can achieve higher torque in comparison to a conventional motor having only one magnetic module.

FIG. 7 shows a plan view of the rotor device 1 from FIG. 1, having a magnetizing installation 8 for magnetizing magnetizable material of the cylinder elements 3, 4.

More specifically, FIG. 7 shows a snapshot of a method for magnetizing the rotor device 1.

The method here utilizes the described rotor device 1 and a magnetizing installation 8 which is disposed in the intermediate space between the cylinder elements 3, 4 of the rotor housing element 2 of the rotor device 1.

The magnetizing installation 8 has various coil elements 9 for generating a magnetic field, and accordingly also various core elements, in particular iron cores, for amplifying the magnetic field that is able to be generated by the coil elements 9.

The method for magnetizing the rotor device 1 now fundamentally comprises the following steps:
positioning the rotor device 1 and the magnetizing installation 8;
inserting the magnetizing installation 8 into the intermediate space between the cylinder elements 3, 4 of the rotor housing element 2 of the rotor device 1;
collectively magnetizing the first and the second magnetic module 5, 6 such that the cylinder elements 3, 4 are identical in terms of the pole pairs and the number of pole pairs; and subsequently extracting the magnetizing installation 8 from the intermediate space.

The magnetizing of the first and the second magnetic module 5, 6 here of course includes that the magnetizing installation 8 for a specific period is supplied with electric power for generating magnetic fields.

List of reference signs

| | |
|---|---|
| 1 | Rotor device |
| 2 | Rotor housing element |
| 3 | First cylinder element |
| 4 | Second cylinder element |
| 5 | First magnetic module |
| 6 | Second magnetic module |
| 7 | Disc element |
| 8 | Magnetizing installation |
| 9 | Coil element |
| 10 | Stator device |
| 11 | Stator housing element |
| 12 | Base element |
| 13 | Wall element |
| 14 | Axle element |
| 15 | Securing installation |
| 16 | Housing part |
| 17 | Tooth element |
| 18 | Inner end |
| 19 | Outer end |
| 20 | Receptacle |
| 21 | Coil assembly |
| 22 | Sub-face |
| 23 | Sub-face |
| 30 | Motor |
| 31 | Rolling bearing |
| 32 | Motor housing element |
| 3-IM | Inner shell face |
| 3-AM | Outer shell face |
| 4-IM | Inner shell face |
| 4-AM | Outer shell face |
| IS | Internal side |
| AS | External side |
| R | Radial direction |

1. A rotor device for a flat brushless electric motor for a roof system of an automobile, having:
a rotor housing element having a first cylinder element and a second cylinder element;
wherein the cylinder elements are configured so as to be hollow-cylindrical, have different internal and external diameters such that a stator device is able to be disposed between the cylinder elements, and are concentrically aligned with one another; and
wherein at least one magnetic module is disposed on each cylinder element.

2. The rotor device according to claim 1,
wherein the first cylinder element has a first magnetic module;
wherein the first magnetic module is configured so as to be hollow-cylindrical;
wherein the first cylinder element has an inner shell face and an outer shell face;
wherein the first magnetic module is disposed on the outer shell face of the first cylinder element;
wherein the first magnetic module comprises a magnetizable material.

3. The rotor device according to claim 1,
wherein the second cylinder element has a second magnetic module;
wherein the second magnetic module is configured so as to be hollow-cylindrical;
wherein the second cylinder element has an inner shell face and an outer shell face;
wherein the second magnetic module is disposed on the inner shell face of the second cylinder element; and
wherein the second magnetic module comprises a magnetizable material.

4. The rotor device according to claim 1,
wherein the rotor housing element comprises an annular disc element which in the radial direction has an internal side and an external side;
wherein the first cylinder element is disposed on the internal side;
wherein the second cylinder element is disposed on the external side;
wherein the internal side of the disc element and the inner shell face of the first cylinder element transition into one another in a planar manner;
wherein the external side of the disc element and the outer shell face of the second cylinder element transition into one another in a planar manner;
wherein the rotor housing element is configured in a unitary manner with the cylinder elements and the disc element; and
wherein the rotor housing element is produced by a deep-drawing method or by a pressing method.

5. A method for magnetizing a rotor device having:
a rotor device according to claim 1;
a magnetizing installation which is able to be disposed in the intermediate space between the cylinder elements of the rotor housing element of the rotor device;
wherein the magnetizing installation has at least one coil element for generating a magnetic field, and at least one core element, for amplifying the magnetic field that is able to be generated by at least one coil element
wherein the method comprises the following steps:
positioning the rotor device and the magnetizing installation;
inserting the magnetizing installation in the intermediate space between the cylinder elements of the rotor housing element of the rotor device;
collectively magnetizing the first and the second magnetic module such that the cylinder elements are identical in terms of the pole pairs and the number of pole pairs; and
extracting the magnetizing installation from the intermediate space.

6. A stator device for a flat brushless electric motor, for a roof system of an automobile, having:
a stator housing element having a base element and a wall element which are mutually disposed in such a manner that the stator housing element is configured in the shape of a pot; and
an axle element for externally disposing a rolling bearing for a rotor device.

7. The stator device according to claim 6,
wherein the axle element is disposed in the center of the stator housing element and such that the axle element and the wall element, when viewed in the cross section, extend away from the base element in the same direction;
wherein the stator housing element and the axle element are configured so as to be mutually integral;
wherein the axle element comprises a securing installation for securing a rolling bearing.

8. The stator device according to claim 6,
wherein the stator device comprises a housing part for attaching a multiplicity of tooth elements;
wherein the housing part is configured as a disc-shaped plate;
wherein a multiplicity of tooth elements are preferably fixedly connected to the housing part.

9. The stator device according to claim 6,
wherein the stator device has at least one tooth element for winding a coil assembly thereon;
wherein the at least one tooth element has an inner end and an outer end and disposed therebetween a receptacle for a wound coil assembly;
wherein the stator device comprises a coil assembly having a wire element which is wound about the receptacle of the tooth element;
wherein the at least one tooth element on the inner end and on the outer end has a sub-face of an internal circumferential face and a sub-face of an external circumferential face, so as to form an internal circumferential face and an external circumferential face;
wherein the internal circumferential face is preferably adapted to an outer shell face of a first cylinder element of a rotor device, such that the internal circumferential face and the outer shell face are able to be mutually separated by way of an air gap;
wherein the external circumferential face is adapted to an inner shell face of a second cylinder element of a rotor device, such that the external circumferential face and the inner shell face are able to be mutually separated by way of an air gap.

10. A flat brushless electric motor for a roof system of an automobile, having:
a rotor device according to claim 1; and
a stator device according to claim 6;
wherein the rotor device by way of a rolling bearing is connected to the axle element of the stator device such that the rotor device and the stator device are rotatable relative to one another.

11. The method for magnetizing a rotor device of claim 5, wherein the at least one core element is an iron core.

12. The stator device according to claim 7, wherein the securing installation is a circlip having a corresponding clearance on the axle element.

13. The stator claim 8, wherein the multiplicity of tooth elements integrally cast with the housing part.
